(19) United States
(12) Patent Application Publication
(10) Pub. No.: US 2024/0149208 A1
(43) Pub. Date: May 9, 2024

(54) CARBON DIOXIDE CAPTURE DEVICE AND HVAC SYSTEM HAVING THE SAME

(71) Applicant: Qatar Foundation for Education, Science and Community Development, Doha (QA)

(72) Inventors: Abdulkrem Amhamed, Doha (QA); Yasser Abdellatif, Doha (QA); Ahmed Sodiq, Doha (QA); Tareq A. Al-Ansari, Doha (QA)

(21) Appl. No.: 18/387,558

(22) Filed: Nov. 7, 2023

Related U.S. Application Data
(60) Provisional application No. 63/423,309, filed on Nov. 7, 2022.

(51) Int. Cl. B01D 53/04; B01D 53/06; B01D 53/26; F24F 3/16; F24F 8/108

(52) U.S. Cl. CPC B01D 53/0438; B01D 53/0462; B01D 53/06; B01D 53/261; F24F 3/16; F24F 8/108; B01D 2253/102; B01D 2253/108; B01D 2253/204; B01D 2257/504; B01D 2257/80; B01D 2259/4508; F24F 2203/1032

(57) ABSTRACT

A carbon dioxide capture device and an HVAC system are provided. The carbon dioxide capture device includes a direct air capture unit having a carbon dioxide filter, and an induction heating unit coupled with the direct air capture unit. The HVAC system includes the carbon dioxide capture device and a desiccant unit.

### CROSS REFERENCE TO RELATED APPLICATIONS

The This application claims the benefit of U.S. Provisional Application No. 63/423,309 filed Nov. 7, 2022, which is incorporated herein by reference in its entirety.

### BACKGROUND

The increase in the global atmospheric CO₂ concentration resulting from over a century of combustion of fossil fuels has been associated with significant global climate change. This has led to poor indoor air quality. Traditional methods of carbon capture such as precombustion and post combustion CO₂ capture CO₂ from large point sources and can only help slow the rate of increase of the atmospheric CO₂ concentration. Traditional methods are also costly. Existing HVAC structure, low temperature medium, and humidity swings have the potential to harness CO₂ cheaply and efficiently. Therefore, a more efficient and cost-effective CO₂ capture device is desired.

### SUMMARY

According to one non-limiting aspect of the present disclosure, an exemplary embodiment of a carbon dioxide capture device is provided. In one embodiment, the carbon dioxide capture device includes a direct air capture unit having a carbon dioxide filter, and an induction heating unit coupled with the direct air capture unit.

According to another non-limiting aspect of the present disclosure, an exemplary embodiment of a HVAC system is provided. In one embodiment, the HVAC system includes the carbon dioxide capture device and a desiccant unit.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows an air way diagram through solid desiccant and direct air capture units in Air Handling Units (AHUs), according to an example embodiment of the present disclosure.

FIG. 2 shows a graph of adsorbent CO₂ isotherm based on Toth model, according to an example embodiment of the present disclosure.

FIG. 3 shows a graph of the effect of relative humidity on Direct Air Capture (DAC) regeneration energy, according to an example embodiment of the present disclosure.

FIG. 4 shows a desiccant system operational concept, according to an example embodiment of the present disclosure.

FIG. 5 shows a diagram of the main existing Direct Air Capture (DAC) companies with their regeneration methods, according to an example embodiment of the present disclosure.

### DETAILED DESCRIPTION

The present disclosure generally relates to a carbon dioxide capture device and an HVAC system having the same.

In the Disclosed Invention, the use of solid desiccant and induction heating technologies features to enhance the direct capture of CO₂ from the atmosphere is disclosed. The main function of solid desiccants is to reduce the moisture in air using physisorption or chemisorption. The desiccant is proposed to replace moisture condensation in the HVAC system. The function of induction heating is to speed up the rate of desorption and to ease the powering of Direct Air Capture (DAC) by renewable energy. The Disclosed Invention aims to make use of the desiccant moisture adsorption capability and induction heating to increase DAC system capture capacity per time, reduce regeneration energy, decrease CO₂ cost and produce water as a byproduct. The CO₂ is captured using physisorption or chemosorption material and then released based on temperature swing adsorption (TSA) or moisture swing adsorption (MSA) using the heat from induction heating. The products (CO₂ and water) can be used in different application such as greenhouse or formic acid production.

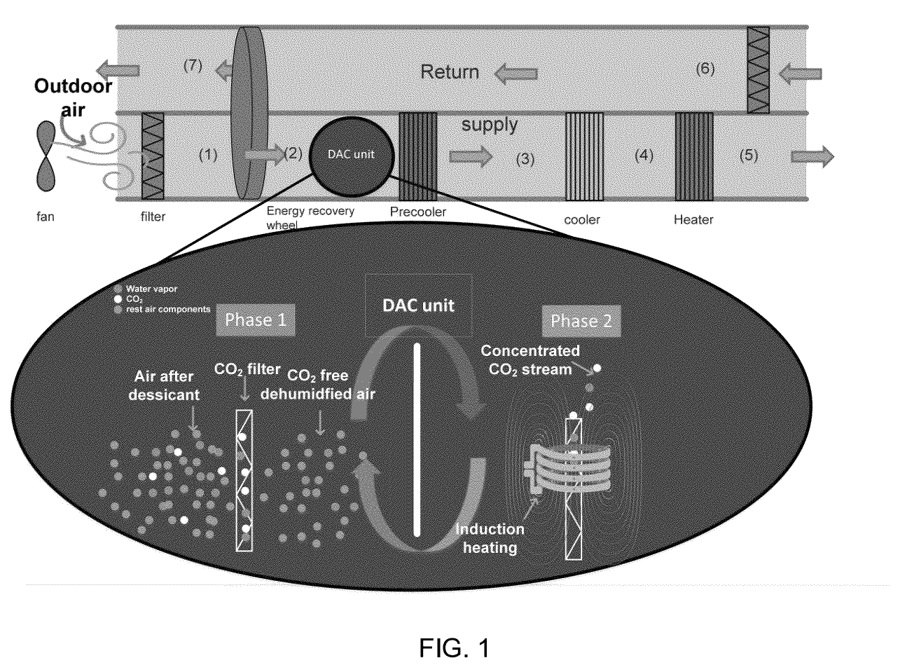

FIG. 1 shows an air way diagram through solid desiccant and direct air capture units in Air Handling Units (AHUs). Specifically, FIG. 1 shows a diagram of how the existing technology (Desiccant), induction heating and new technology (DAC) will be combined inside the HVAC system. The ambient air is pulled by the air handling unit (AHU) fans. The moisture is removed from the pulled air using rotating solid desiccant, cooled, and then passed by the proposed CO₂ capture rotary unit to supply air that meets thermal comfort standards with low CO₂ concentrations.

The use of solid desiccant, which reduces the moisture in air, gives advantage for a certain adsorption technique (physisorption). The filter material is comprised of one of the materials that use physisorption such as (MOFS, Activated Carbon or Zeolites). The capture and regeneration of CO₂ includes continuous processes by the integration of the quick heating using induction heating. Moreover, the low temperature air (approximately 12° C.) is favorable for higher adsorption capacity and rate. These materials have the advantages of high pore size, stability, and nontoxicity. The CO₂ capture unit is optimized to operate with minimum pressure drop but with maximum surface area enough for the incoming air.

The Disclosed Invention proposes two regeneration processes: TSA and MSA. The energy requirements of TSA and MSA can be recovered within the system. In MSA, the CO₂ is captured when the adsorption material is dry and then released by introducing moisture in the filter material. In TSA, the CO₂ is captured at low temperature (at about 10-22° C. depending on the type of air conditioning system) and then regenerated at high temperature (more than 60° C.). Both TSA and MSA require heating which can be provided by induction heating. The induction heating can reduce the regeneration time and allow for localized and precise temperature control. Reducing regeneration time will result into a higher CO₂ capacity per unit of time. The system also adds a benefit of water production through the regeneration process.

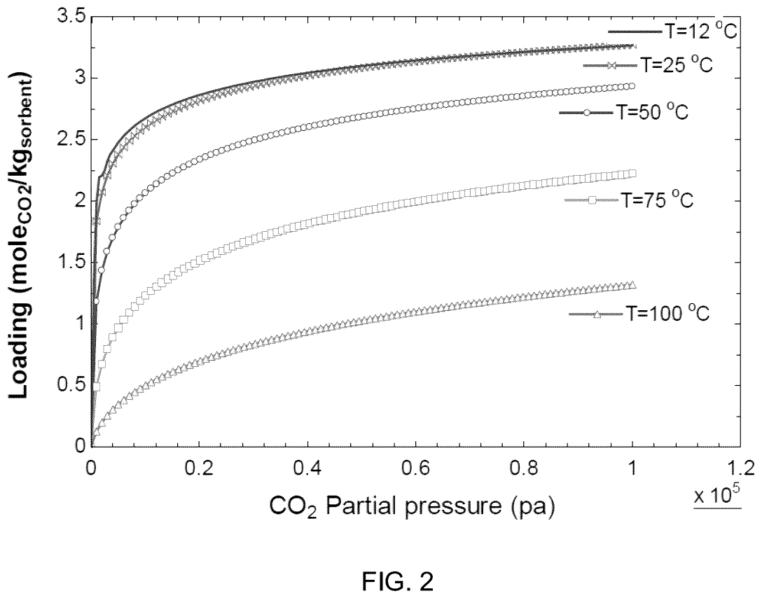

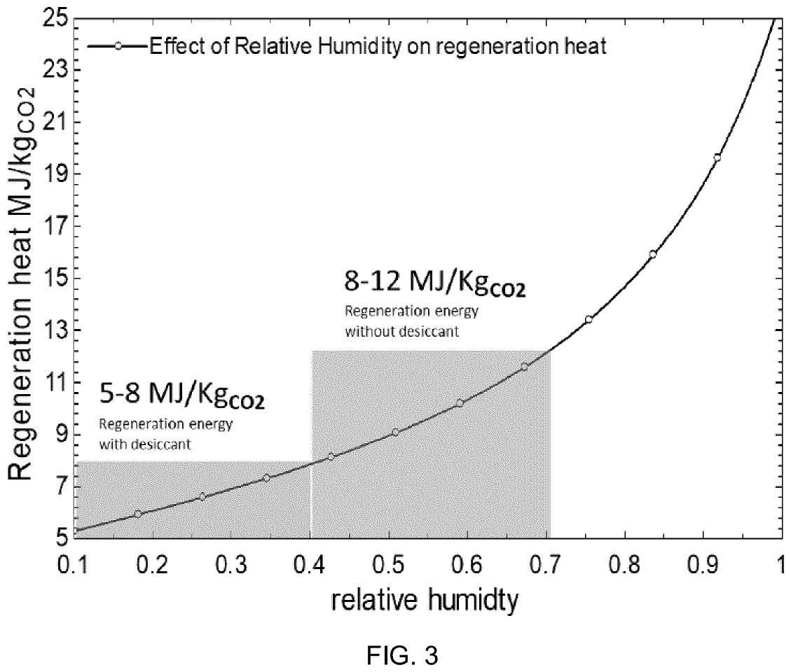

Moreover, a direct air capture unit that uses Temperature vacuum swing adsorption (TVSA) and a selected amine functionalized material (Lewatits VP OC 1065) was modeled. The CO₂ isotherm of the adsorbent was simulated using Toth model as shown in FIG. 2. Specifically, FIG. 2 shows the effect of both CO₂ partial pressure and Temperature on CO₂ loading. As seen in the figure, the loading of CO₂ is increasing by decreasing the temperature, which provides an advantage for the proposed DAC and HVAC integration. Also, at higher temperatures the amount of desorbed CO₂ increases, and the heat required for reaching such temperature can be supplied in minutes using induction heating. The effect of co-adsorption of water with CO₂ on DAC process was accounted by applying the mechanistic co-adsorption model. The results showed that as the relative humidity of air increases the required heat for regeneration gets higher. This is shown in FIG. 3. Based on the experimental results, the integration of desiccant before the DAC unit leads to lower relative humidity of air then to lower regeneration energy. With a desiccant wheel, the regeneration energy is in the range of 5-8 MJ/kgCO₂ while it is in the range of 8-12 MJ/kgCO₂ without desiccant wheel. This is a large difference as far as HVAC-DAC system is concerned. It is equally important to note that the effect of desiccant helps in reducing the cooling load required for condensing the moisture-laden air.

Regarding induction heating, the induction heating assembly within the HVAC-DAC system gives room for easy and timesaving material regeneration as well as adding compactness to the HVAC-DAC architecture.

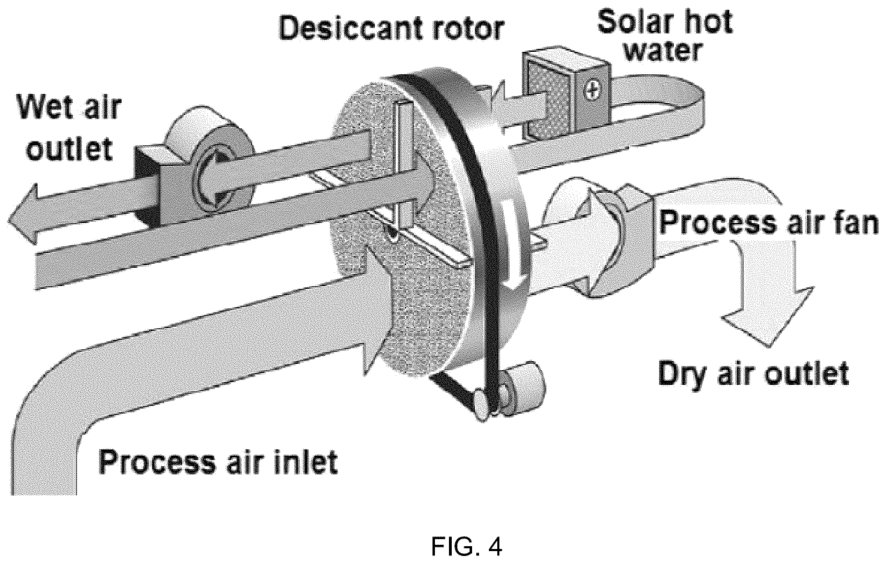

Additionally, as shown in FIG. 4, the main principle behind desiccant is the system's capability for removing or reducing vapors and moisture out of the treated air using a physical sorption of desiccant materials. There are two types of desiccant machines: liquid desiccant machines and solid desiccant machines. Both systems are used to improve conventional cooling systems' energy performance and to improve indoor air quality in commercial and residential buildings. Various cycles have been developed for the improvement of thermal performance and COP and cooling capacity of rotary desiccant-based air-conditioning system. Market available desiccant systems are liquid spray towers, solid packed tower, rotating horizontal bed, multiple vertical bed and rotating desiccant wheel.

Also, induction heating is a process where a high-frequency alternating magnetic field induces eddy currents inside the conductive materials. It also changes the direction of aligned domains of the magnetic materials. These two phenomena cause a rise in temperature either due to ohmic resistance or by magnetic dissipation. The process was used some industrial applications like welding, cooking and heat treatment. The advantage of the process is the precise temperature control and the high heat rate. The regeneration of CO₂ using induction heating takes only minutes compared to normal TSA process, which reaches hours in literature. The short regeneration time allows for almost continuous operation of the AHU, which highlights the importance of using induction heating.

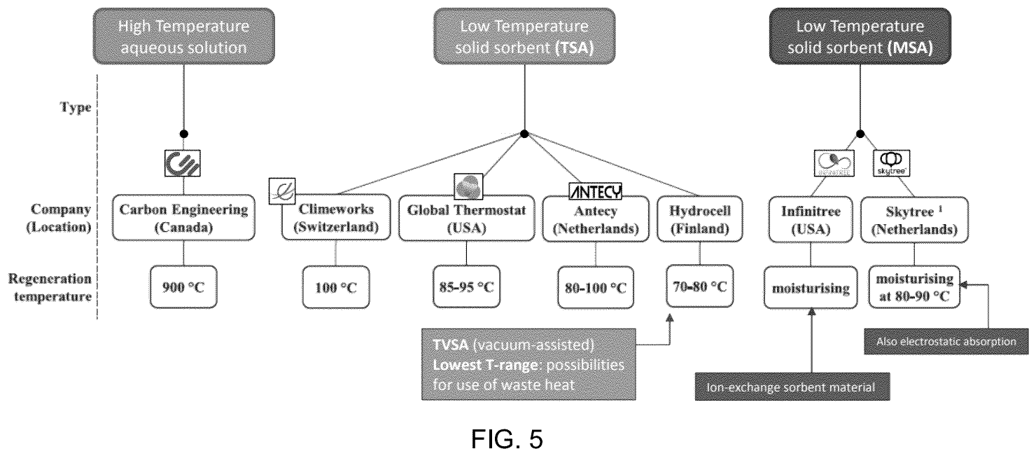

Additionally, current DAC sorbents are classified into liquid and solid sorbents. Solid sorbents do not lose heat to evaporation as liquids. As such, DAC has better kinetics and is more effective in preventing the loss of volatiles to the atmosphere. Relatedly, FIG. 5 shows the main DAC companies, their sorbent materials and regeneration method. As seen in the figure, all companies are using solid sorbents except Carbon Engineering (a carbon capture startup based in Canada), which uses aqueous solution (KOH). Through the solid sorbent, there are three main classifications, which are physisorption, chemisorption, and moisture swing sorption. The chemisorption and moisture swing are used by different companies, however, there is no company that currently uses the physisorption technique for DAC application. The main reason is that physisorption have very low selectivity of CO₂ compared to vapor, which makes its usage in DAC system irrelevant. On the other hand, the physisorption materials have higher surface area and require less energy compared to chemosorption

Physisorption materials are promising materials in direct air capture of CO₂ because they have a larger CO₂ capacity compared to chemisorption, and they need lower energy for regeneration. The main barrier of using such materials is that they adsorb high water/CO₂ ratio. As a solution, the Disclosed Invention includes the integration of a desiccant wheel before the DAC system to reduce the air moisture content before the DAC filter, resulting in more efficient direct air capture process. This disclosure highlights some quantitative benefits derived from our built mathematical model such as reducing the regeneration energy and increasing the CO₂ capacity of the capturing material. Moreover, the Disclosed Invention uses the DAC within the HVAC system and uses the desiccant wheel in the air-handling unit. However, the time required for regeneration by conventional regeneration approaches will cause interruption in the HVAC air supply, which motivates the Disclosed Invention's use of induction heating, as it has been proved to be faster and more efficient.

The Disclosed Invention aims to: reduce heat stress predicted to affect productivity if nothing is done to address the current global climate change challenges; improve cooling efficiency by reducing the CO₂ concentration indoors; reduce incessant sick building syndrome in places like Qatar due to poor air quality that is brought about by high concentration of CO₂; address continuous demand of green CO₂ by industries that utilize pure CO₂ for chemical (e.g. formic acid) production; reduce heat Island effect in places like Qatar; and support contributions to global climate change commitments.

To address the aforementioned goals, the Disclosed Invention: treats (either via coating or thermal fusion) filter material with nanomaterials (the proposed adsorbents); places the filter material after the refrigeration cycle in the A/C to benefit from low temperature adsorption; harvests low grade waste heat from the existing A/C and combine with electrical heating for TSA regeneration or make use of humidity difference between the supply air and return air especially with the existence of desiccant for MSA regeneration; stores the pure recovered CO₂ in an ISO tank; supplies the stored CO₂ to end-users for utilization; uses desiccants that eliminate the required cooling for moisture condensation; the regeneration of desiccant allows the air to hold more moisture which will be condensed to regenerate the CO₂ from DAC unit; and by using induction heating for higher heating rate, faster cycle and allowing for electrification of the process.

In turn, the Disclosed Invention utilizes existing infrastructure (the A/C unit) to reduce the DAC operating cost. The Disclosed Invention is not geographically constrained because it can be applied even in regions where heaters are used, in which case the filter will be placed at the upstream to benefit from the low temperature adsorption. Relatedly, the Disclosed Invention utilizes low grade waste heat in the existing A/C as part of regeneration energy needed for desorption. Importantly, the Disclosed Invention enhances indoor air quality and uses ecofriendly and non-toxic adsorbents.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A carbon dioxide capture device, comprising:
a direct air capture unit having a carbon dioxide filter, and
an induction heating unit coupled with the direct air capture unit.

2. The carbon dioxide capture device of claim 1, wherein the direct air capture unit is configured to use temperature vacuum swing adsorption.

3. An HVAC system, comprising:
a desiccant unit, and
a carbon dioxide capture device including:
a direct air capture unit having a carbon dioxide filter, and
an induction heating unit coupled with the direct air capture unit.

4. The HVAC system of claim 3, wherein the desiccant unit includes a desiccant wheel.

5. The HVAC system of claim 4, wherein the desiccant wheel is comprised of one of MOFS, Activated Carbon or Zeolites.

6. The HVAC system of claim 5, wherein the heat induction unit operates at about 12° C.
